(19) United States
(12) Patent Application Publication
(10) Pub. No.: US 2002/0042824 A1
(43) Pub. Date: Apr. 11, 2002

(54) Method for controlling access to a data communication network

(75) Inventors: Felice Vinati, Villa Carcina (IT); Samuele Vinati, Brescia (IT)

Correspondence Address: MODIANO & ASSOCIATI, Via Meravigli, 16, Milano, 20123, IT

(73) Assignee: GESTWEB S.p.A.

(21) Appl. No.: 09/880,139

(22) Filed: Jun. 14, 2001

(30) Foreign Application Priority Data
Oct. 10, 2000 (IT) MI2000A002189

(51) Int. Cl. G06F 15/173

(52) U.S. Cl. 709/225

(57) ABSTRACT

A method for controlling access to a data communication network, comprising the steps of:

upon connection of a user to a network service provider, checking the data of the user who wishes to make the connection and comparing the data with a database in order to define a user profile;

according to the user profile, allowing free access to the network, and if the user is a minor, accessing the network with a controlled navigation step.

### BACKGROUND OF THE INVENTION

The present invention relates to a method for controlling access to a data communication network. More particularly, the invention relates to a method for controlling access to the Internet.

It is known that the increasing growth of data communication networks, such as the Internet, has led a very large number of users to go online every day.

On the other hand, the increasing growth of the data communication network has caused information of various kinds to be placed on the network, with a consequent proliferation of sites containing data and information, as well as images, videos and the like, whose viewing should be reserved exclusively to adult users.

However, it is evident that the simplicity of access to a data communication network, such as for example the Internet, allows anyone, and especially minors, who usually have a considerable time available, to access the network without any restriction, being able to navigate it and visit practically any kind of site without their minor age being protected.

Furthermore, the parents of minors cannot know which sites their children visit and therefore are practically unable to perform any kind of control.

### SUMMARY OF THE INVENTION

The aim of the present invention is to provide a method for controlling access to a data communication network which allows to distinguish between network access requested by a minor and access requested by an adult user and then direct navigation according to the user's profile.

Within this aim, an object of the present invention is to provide a method for controlling access to a data communication network which, in the case of a minor user, allows to perform a controlled navigation, thus excluding sites that should not be viewed by minors.

Another object of the present invention is to provide a method for controlling access to a data communication network which allows to tag the various sites according to their suitability or unsuitability for viewing by minors.

Another object of the present invention is to provide a method for controlling access to a data communication network which is highly reliable, relatively simple to provide and at competitive costs.

This aim and these and other objects which will become better apparent hereinafter are achieved by a method for controlling access to a data communication network, characterized in that it comprises the steps that consist in:

upon connection of a user to a network service provider, checking the data of the user who wishes to make the connection and comparing such data with a database in order to define a user profile;

according to the user profile, allowing free access to said network, and if the user is a minor, accessing said network with a controlled navigation step.

### BRIEF DESCRIPTION OF THE DRAWINGS

Further characteristics and advantages of the invention will become better apparent from the description of a preferred but not exclusive embodiment of the method according to the invention, illustrated only by way of non-limitative example in the accompanying drawings, wherein:

FIG. 1 is a block diagram of the process for the connection of a user to a data communication network by means of the method according to the present invention;

FIG. 2 is a flowchart of the user identification procedure used in the method according to the present invention; and

FIG. 3 is a block diagram of the verification of the Internet pages that can be performed by way of the method according to the present invention.

### DESCRIPTION OF THE PREFERRED EMBODIMENTS

With reference to the figures, the method according to the invention is as follows.

The user, generally designated by the reference numeral 1, upon requesting connection to a data communication network by calling through his computer the telephone number of a service provider 2 with which he has previously agreed an appropriate contract for the service, is identified by being asked a password and a user identification word.

The identification step is generally designated by the reference numeral 3.

At this point the identification procedure checks, by accessing a database 4, the information received from the user connected to the service provider 2, and identifies the user profile, ascertaining whether the user is an adult or a minor and, in the latter case, the age group to which the minor belongs.

The identification procedure operates consequently in two different modes:

if the user profile corresponds to an adult, step 5, and therefore has no restrictions to the network navigation, the access by means of the computer of the user 6 is unrestricted. Access to the network in this case is designated by the reference numeral 7.

Otherwise, if the user profile corresponds to a minor, step 8, access to the network by means of the computer of the user 9 (who in this case is a minor) occurs in a controlled manner, designated by the reference numeral 10.

Essentially, therefore, the method according to the invention employs user registration means for accessing a data communication network, which can be identified by the service provider 2, means for authenticating the user connected by means of the service provider 2, which can be identified by the identification method 3, and at least one database 4 which contains registered user profiles.

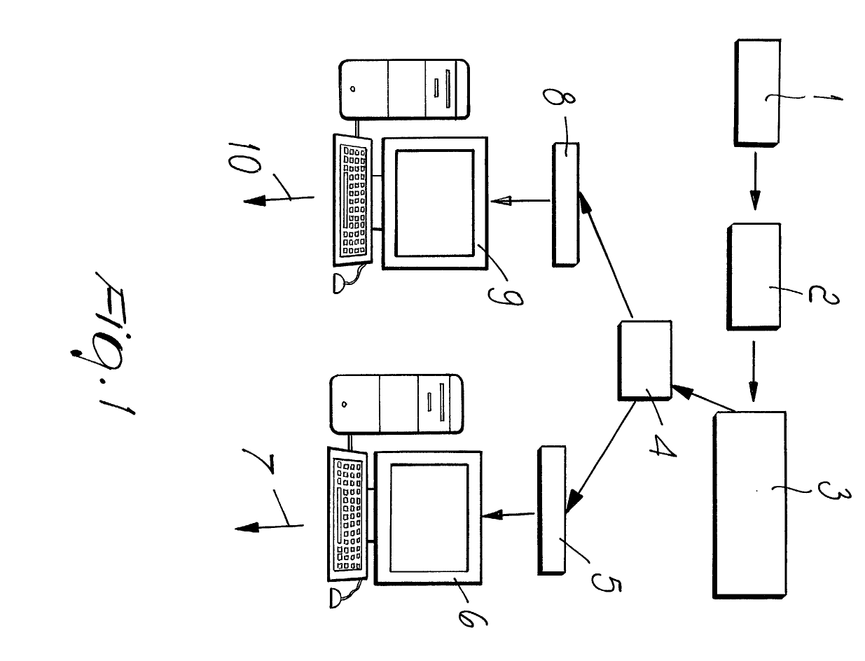

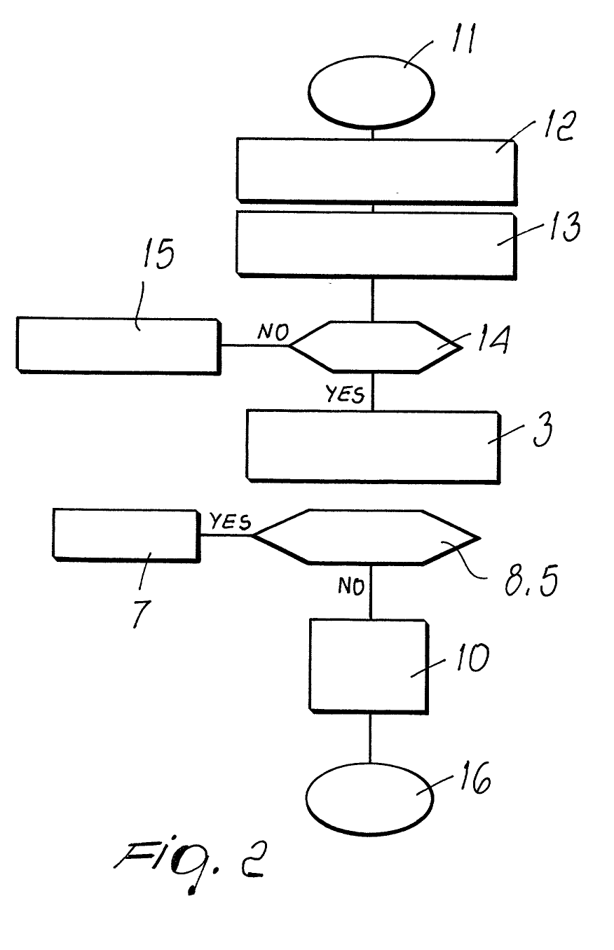

Essentially, the flowchart of the method according to the invention, which corresponds to the block diagram of FIG. 1, is shown in FIG. 2, in which identical reference numerals designate identical steps.

Essentially, the reference numeral 11 designates the previously described step of registering a user 1 with the service provider 2, the reference numeral 12 designates a step of requesting access to the network, and the reference numeral 13 designates the request for authentication by the service provider 2, which is performed by sending, by the user, a password and a user identification word.

The step 14 represents the check performed by the service provider 2 as to whether the user 1 is registered or not; if he is not registered, the connection is terminated, step 15; otherwise the method moves on to step 3 for user profile authentication.

Finally, the step 16 represents the end of the registration step 11.

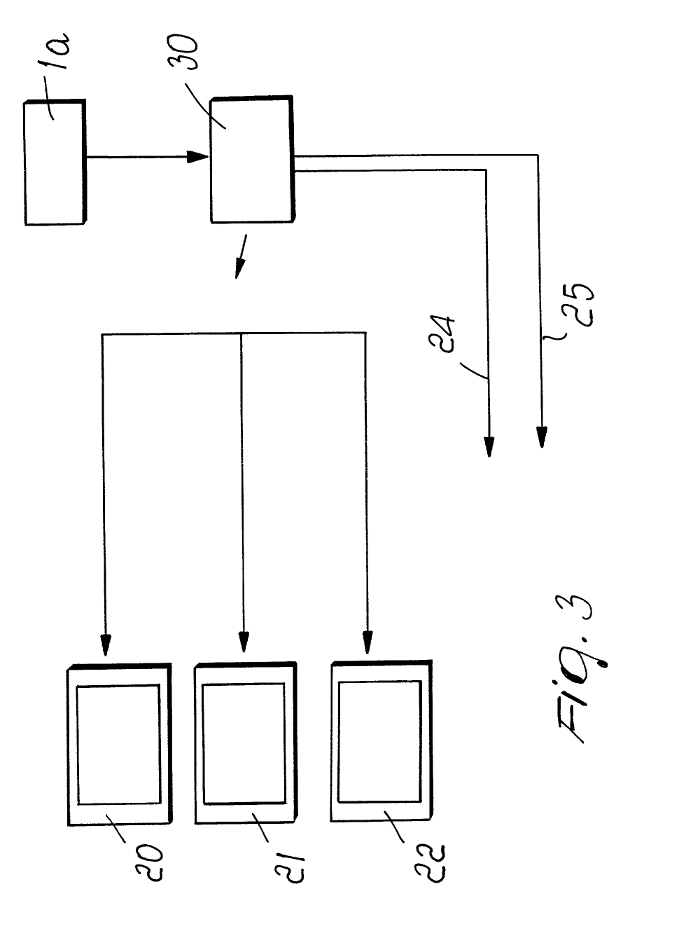

The controlled navigation procedure step 10 is shown in detail in FIG. 3.

During this step, therefore when the user 1 is recognized as a minor, navigation is controlled and the list of sites requested by the user who is navigating is sent for example by e-mail to the parents of the minor user.

In the controlled navigation procedure, all the sites that can be identified as being accessible by a minor have an identification key, and all the sites that cannot be accessed by a minor are identified by a different identification key.

The method according to the invention therefore provides for verification of the existence of said accessibility key or, alternatively, of said non-accessibility key.

In FIG. 3, the reference numeral 20 designates an inaccessible site, which is accordingly tagged with the non-accessibility key, while the reference numeral 21 designates a site which is accessible to minors and is therefore tagged with the accessibility key.

Finally, the reference numeral 22 designates an unidentifiable site, i.e., a site which is not tagged by any of the above keys. Essentially, once the user has been identified as a minor, who is designated in this case by the reference numeral 1a, the method according to the invention provides, by means of appropriate software means 30, a step of identifying said accessibility or non-accessibility keys together with a step of disabling all ports enabled for credit-card transactions and the like.

If the site that the user wishes to visit is not tagged with the accessibility key, the page is not transmitted; otherwise it is transmitted but the site, i.e., all the pages of the site, are checked as a precaution for the existence of certain key words that are suitable to define the identity of the site.

If instead the accessibility or non-accessibility key is not present in the site that the user 1a intends to view, the controlled navigation procedure 10 checks all the pages of the site in order to determine the existence of the above defined keywords.

Only if such keywords have not been found in the pages of the site can said site be considered freely accessible by the user 1a.

Essentially, the method according to the invention allows to verify the accessibility of a site directly at the service provider 2, who is able to identify the profile of the user who wishes to perform the connection and therefore to determine whether he is an adult or a minor.

The navigation procedure 10 according to the invention furthermore provides a step 24 for sending the navigation report to the parent of the minor, as well as a step 25 of sending the navigation report, in this case anonymously, i.e., without knowing who the user who performed the navigation is, to an association and/or foundation provided for this purpose.

In practice it has been found that the method according to the invention fully achieves the intended aim and objects, since it allows to perform connections of users to the network, taking into account the age of the user and therefore, in the case of minor users, guiding navigation in a controlled manner.

The method thus conceived is susceptible of numerous modifications and variations, all of which are within the scope of the inventive concept; all the details may furthermore be replaced with other technically equivalent elements.

The disclosures in Italian Patent Application No. MI2000A002189 from which this application claims priority are incorporated herein by reference.

What is claimed is:

1. A method for controlling access to a data communication network, comprising the steps of:
upon connection of a user to a network service provider, checking data of the user who wishes to make the connection and comparing said data with a database in order to define a user profile;
according to the user profile, allowing free access to said network, and if said user is a minor, accessing said network with a controlled navigation step.

2. The method according to claim 1, wherein said user profile identification step consists in comparing the data entered by said user in order to access the network with a database which contains the profiles of users registered with said service provider.

3. The method according to claim 1, wherein said controlled navigation step comprises checking for the presence, in the sites that said user wishes to visit, of a keyword suitable to identify said site as accessible or not accessible to the minor user.

4. The method according to claim 3, wherein said navigation step furthermore comprises, if said site that the user wishes to visit is tagged by an accessibility key, the step that consists in checking for the presence of preset keywords in the pages of said site.

5. The method according to claim 3, wherein if said accessibility key or said non-accessibility key are not present in said site that the user intends to visit, a step is performed which consists in checking for the presence of preset keywords in the pages of said site.

6. The method according to claim 1, comprising a step that consists in preparing a report of the navigation performed by said user and in sending said report to the parents of said minor user.

7. A device for controlling access to a data communication network, comprising means for registering at least one user for enabling access to a data communication network;
means for authenticating said user;
means for storing the profile of said user; and
means for controlling the sites that can be visited by said user on said data communication network, in order to allow a controlled navigation of said user on said data communication network if said user is a minor.
